(19) United States
(12) Patent Application Publication
(10) Pub. No.: US 2005/0114791 A1
(43) Pub. Date: May 26, 2005

(54) Cueing mechanism that indicates a display is able to be scrolled

(75) Inventors: Rick E. Bollenbacher, Boca Raton, FL (US); Patrick M. Commarford, Delray Beach, FL (US); Samuel L. Karns, Delray Beach, FL (US); Richard P. Miranti, Boca Raton, FL (US); Rodrigo J. Pastrana, Delray Beach, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/718,441

(22) Filed: Nov. 20, 2003

(51) Int. Cl. G06F 3/00

(52) U.S. Cl. 715/787; 715/786; 715/784; 715/830; 715/853; 715/854

(57) ABSTRACT

A method for indicating that a content page is scrollable can include the step of displaying a content page within a display area. A determination can be made that at least a portion of the displayed content page is scrollable. Responsive to the determination, a flyover can be displayed to indicate that the content page is scrollable, where the flyover can be a graphical user interface (GUI) object independent of the content page. The flyover can be a fixed object that appears on top of other windows in the GUI.

### BACKGROUND

1. Field of the Invention

The present invention relates to the field of computer software and, more particularly, to a cueing mechanism for visual displays.

2. Description of the Related Art

Computer software designers often find it necessary to provide users with a scrolling mechanism to create a virtual display larger than the physical display of a computing device. The need for scrolling mechanisms is especially prevalent when applications are developed for mobile computing devices, which can include tiny display screens. One problem with utilizing scrolling mechanisms is that a portion of the application's user population will become confused by the scrolling mechanism and not recognize that addition information can be displayed by scrolling. To many of these users, the appearance of a scroll bar alone is insufficient to notify the users that scrolling capabilities exist. Further, mobile devices often disfavor the use of scroll bars in an effort to conserve space within a limited viewing area.

One current solution to this problem is to specifically design content pages so that text and/or graphics at the borders of the viewing area are only partially displayed, thereby providing users with a visual indication that more information is available by scrolling. For example, designers can design content pages so that the bottom line of text falls in such as way that the tops of the letters are visible, but the bottoms are hidden. This solution can be highly inefficient as it can require content providers to tune text size, content, spacing, or a combination of these variables. The problem is exacerbated when content is presented on multiple devices (having screens of varying size) and/or content is designed for multiple operating systems and computing platforms.

Another current solution is to provide an explicit indication within the content of a scrollable page. For example, the last visible line of a scrollable page can end with elipses ( . . . ), an arrow pointing down (or to the right), or the word “more.” While these labels can notify a user that additional content is available by scrolling, placing notifications within content results in the same problem as the prior solution. That is, the solution is highly inefficient in that it places a relatively large burden on application programmers.

### SUMMARY OF THE INVENTION

One aspect of the present invention can include a method for indicating that a content page is scrollable. The method can include the step of displaying a content page within a display area. A determination can be made that at least a portion of the displayed content page is scrollable. Responsive to the determination, a flyover can be displayed to indicate that the content page is scrollable, where the flyover can be a graphical user interface (GUI) object independent of the content page. Moreover, the flyover can be a fixed object that appears on top of other windows in the GUI. When the content page is scrollable vertically, a vertical flyover can be displayed. Similarly, when the content page is scrollable horizontally, a horizontal flyover can be displayed. Multiple flyovers can be simultaneously displayed when a content page is scrollable in multiple directions. The position of the flyover can remain fixed in relationship to the GUI, even though the displayed content can move responsive to scrolling operations.

Additionally, a flyover-close event can be detected resulting in the closing of one or more flyovers. In one embodiment, an occurrence of a scroll event in a direction indicated by the flyover can trigger the flyover-close event. In another embodiment, a determination that the content page has been scrolled so that an end point of the content page has been displayed can trigger the flyover-close event. In yet another embodiment, a configuration editor can be provided for altering at least one of a positioning, appearance, and behavior of the flyover. In still another embodiment, the flyover can be implemented on an operating system level as a generic graphical user interface object. For example, the flyover can be implemented on a mobile operating system, such as the operating system of a personal data assistant (PDA) or a cellular telephone.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1A is a schematic diagram of a graphical user interface (GUI) illustrating the use of a flyover scroll indicator in accordance with the inventive arrangements disclosed herein.

FIG. 1B is a schematic diagram of another GUI illustrating the use of a flyover scroll indicator in accordance with the inventive arrangements disclosed herein.

FIG. 1C is a schematic diagram of yet another GUI illustrating the use of a flyover scroll indicator in accordance with the inventive arrangements disclosed herein.

FIG. 1D is a schematic diagram of still another GUI illustrating the use of a flyover scroll indicator in accordance with the inventive arrangements disclosed herein.

FIG. 2 is a flowchart illustrating a method for implementing a flyover scroll indicator in accordance with the inventive arrangements disclosed herein.

### DETAILED DESCRIPTION OF THE INVENTION

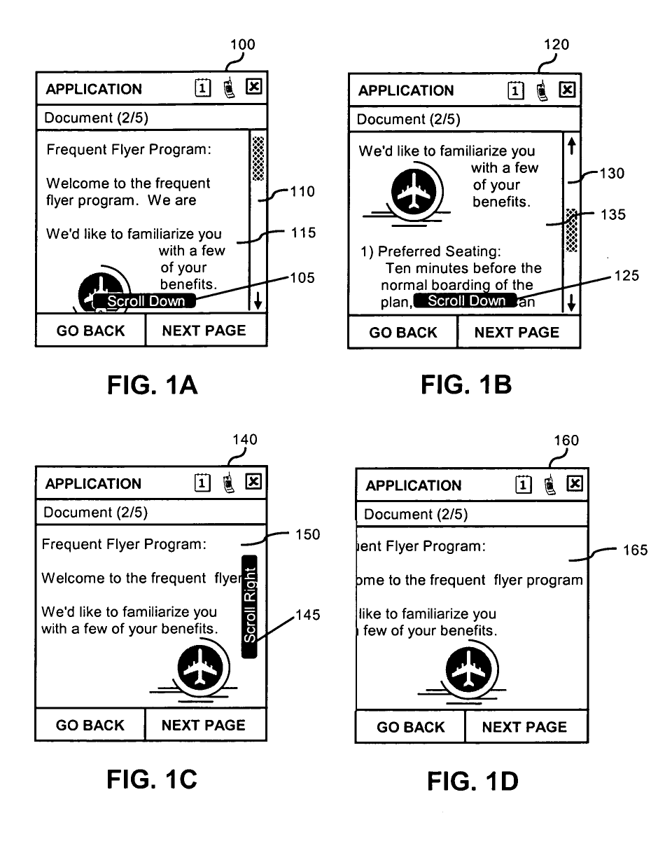

FIG. 1A is a schematic diagram of a graphical user interface (GUI) 100 illustrating the use of a flyover scroll indicator in accordance with the inventive arrangements disclosed herein. The GUI 100 can include a content page 115, a scroll bar 110, and a flyover 105. The content page 115 can be a page of content that exceeds the display boundaries of the application in which it is presented. More specifically, the bottom most portion of the content page 115 can include data which is not displayable.

The scrollbar 110 can be an element for navigating a virtual display area larger than the actual display area of GUI 100. The scrollbar 110 can be presented on the right hand side of GUI 100 and can include a slide indicator in the upper portion of the scrolling area. Accordingly, the scrollbar 110 can indicate that the content page 115 can contain additional content that can be viewed by scrolling the display vertically.

The flyover 105 can be a visual indicator that indicates that the content page 115 is scrollable. The flyover 105 can be implemented in a content-independent fashion. For example, in one embodiment, the flyover 105 can be a popup window, icon, graphic, or the like that remains on top of displayed windows. As such, the flyover 105 can lack user-selectable move, resize, minimize, maximize, and close functionality. In one embodiment, the flyover 105 can be a visual element that is not activatable by a user. According, the flyover 105 can appear within a predefined fixed location until a flyover-close event occurs.

In one embodiment, a flyover-close event can occur when all the available content of the content page 115 has been displayed for a designated direction. For example, when the content page 115 has been vertically scrolled to the bottom most portion of the content page 115, a flyover-close event can occur resulting in the flyover 105 being removed from view. During the scrolling of the content page 115, the flyover 105 can remain fixed in the GUI 100, even though the underlying displayed content can be altered. In a different embodiment, the flyover-close event can occur when the content page 115 is initially scrolled in the designated direction. For example, when the GUI 100 is initially scrolled in the vertical direction, the flyover 105 can be removed from view (i.e. a flyover-close event can occur).

The flyover 105 can be placed in different portions of the screen in order to indicate the direction in which the content page 115 can be scrolled. For example, when the content page 115 is scrollable in a downward vertical direction, the flyover 105 can appear at the bottom center of the GUI 100 and be labeled “scroll down”. When the content page 115 is scrollable to the right, the flyover 105 can appear at the right side of the GUI 100 and be labeled “scroll right.” Similarly, when the content page 115 is scrollable to the left, the flyover 105 can appear in the left side of the GUI 100 and be labeled “scroll left.” Finally, when the content page 115 is scrollable upwards in the vertical direction, the flyover 105 can appear at the upper center of the GUI 100 and be labeled “scroll up.” When a content page 115 is scrollable in more than one direction, multiple flyovers 105 can be simultaneously presented.

The flyover 105 can be implemented on an operating system level or on an application specific basis. When implemented on the operating system level, the flyover 105 can be a generally applicable GUI element, similar to the scrollbar 110, a menu bar, or a toolbar. That is, the flyover 105 can be a GUI object having predefined events, execution methods, visual characteristics, and the like, thereby permitting the flyover 105 to be commonly utilized by any application executing on the operating system platform including flyover capabilities. When implemented on an application specific basis, the functionality of the flyover 105 can be limited to content pages displayed within the applicable for which it was designed.

The flyover 105 is not limited to any particular GUI expression, and can be expressed in a variety of ways. For example, the flyover 105 can appear with or without a boarder, can be expressed in any font, font color, or background color, can include a text label or not, can include an icon, graphic, directional arrow or not, and the like. Accordingly, the flyover 105 can be expressed in any manner that is visually distinguishable from other visual elements of GUI 100 and can be displayed in any suitable fashion to indicate to a user that the content page 115 is scrollable. Further, a configuration editor (not shown) can be used to customize the appearance, the positioning, and the behavior of the flyover 105 so that user preferences can be taken into account.

FIG. 1B is a schematic diagram of a GUI 120 illustrating the use of a flyover scroll indicator in accordance with the inventive arrangements disclosed herein. The GUI 120 can show the GUI 100 after the content page 115 has been scrolled to display the page depicted as content page 135. The scrolling can be indicated by the positioning of the slide on scroll bar 130, which indicates that further downward scrolling of the content page 135 is possible. During the scrolling process, the flyover 125 can remain fixed at the same relative screen position that it originally had in GUI 100, when labeled flyover 105. The flyover-close event implemented for GUI 120 can require the content page 135 to be scrolled in a designated direction until all the content in that direction is displayed. Accordingly, until the bottom most portion of the content page 135 is displayed (assuming that content page 135 remains loaded in GUI 120), the flyover 125 can remain in a fixed position.

FIG. 1C is a schematic diagram of a GUI 140 illustrating the use of a flyover scroll indicator in accordance with the inventive arrangements disclosed herein. The GUI 140 can show a variation of GUI 100, which is scrollable horizontally instead of vertically. Further, the GUI 140 does not include scroll bars (in order to maximize the area of displayable content). Even without scrollbars, however, the flyover 145 can indicate that the content page 150 can be scrolled to the right, thereby providing the user with adequate notice that additional content can be accessed.

FIG. 1D is a schematic diagram of a GUI 160 illustrating the use of a flyover scroll indicator in accordance with the inventive arrangements disclosed herein. The GUI 160 is substantially similar to GUI 140, with the exception that the content page 150 has been scrolled horizontally to display content page 165. The flyover-close event implemented for GUI 160 can remove the flyover (previously flyover 145) as soon as a scrolling event in a particular direction is initiated. Accordingly, although the content 165 can still be scrolled further to the right, the flyover-close event can have already been enabled, thereby resulting in the flyover being closed (not appearing) in GUI 160.

The GUIs 100, 120, 140, and 160 can be displayed upon a mobile computing device, such as a personal data assistant (PDA) or a cellular telephone. Mobile devices can often have small display screens which vary in size from one to another. The lack of uniformity can make tailoring screens for particular mobile devices difficult, therefore resulting in content pages which often exceed the actual boundaries of a screen. Accordingly, the need to scroll content pages can be more pronounced for mobile devices than other computing devices having more standardized displays.

It should be appreciated by one of ordinary skill in the art, however, that the present invention is not limited to mobile computing devices and can be generally applicable to any computing device including a GUI display. For example, the present invention can be applied to desktop computers, notebook computers, tablet computing devices, electronic computer games and educational toys, computing devices with a holographic and/or a three dimensional display, and the like.

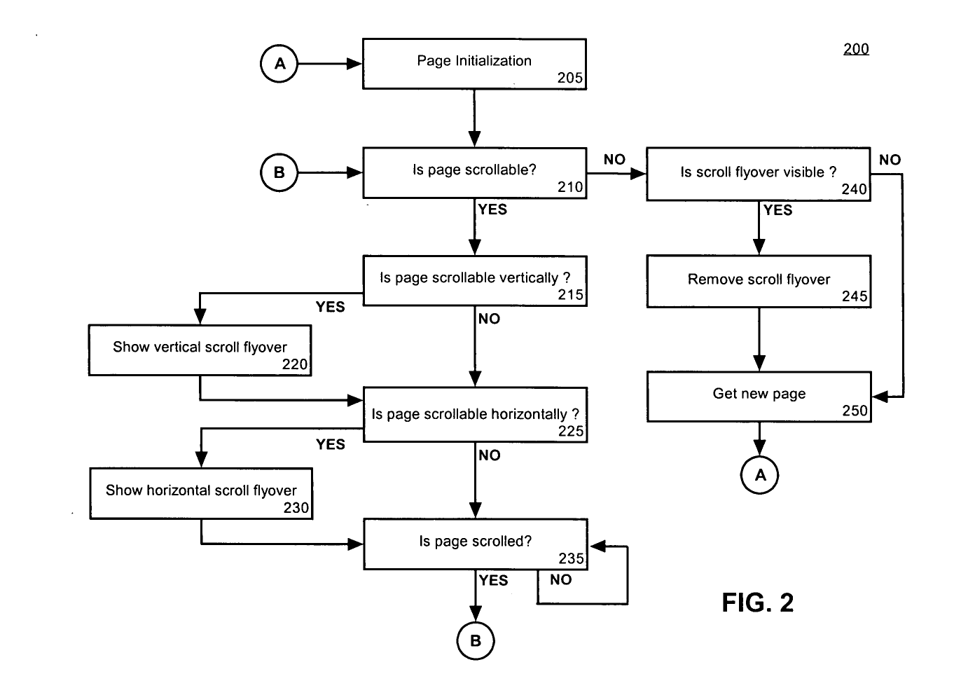

FIG. 2 is a flowchart illustrating a method 200 for implementing a flyover in accordance with the inventive arrangements disclosed herein. The method 200 can be performed in the context of a computing device with a GUI, which has been enabled for flyovers. The method 200 can begin in step 205, where a content page can be initialized or presented within the GUI. In step 210, a determination can be made as to whether the page is scrollable or not. If so, the method can proceed to step 215; otherwise, the method can proceed to step 240.

In step 215, a determination can be made as to whether the page is scrollable in a vertical direction. If a page is vertically scrollable, the method can proceed to step 220, where a vertical scroll flyover can be presented. For example, when the page is scrollable in a downward direction, a flyover labeled “scroll down” can appear towards the bottom of the GUI. When the page is scrollable in an upward direction, a flyover labeled “scroll up” can appear towards the top of the GUI. In one embodiment, when a page is scrollable in both the downwards and the upwards direction, two vertical flyovers, a “scroll down” and a “scroll up” flyover, can simultaneously be displayed. The method can proceed from step 220 to step 225.

Additionally, if the determination of step 215 indicates that the page is not vertically scrollable, the method can proceed from step 215 directly to step 225. In step 225, a determination can be made as to whether a page is scrollable horizontally. If so, the method can proceed to step 230, where a horizontal scroll flyover can be shown. When the page is scrollable to the right, a flyover labeled “scroll right” can appear in a right side of the GUI. When the page is scrollable to the left, a flyover labeled “scroll left” can appear in a left side of the GUI. In one embodiment, both a “scroll right” and a “scroll left” flyover can simultaneously appear to indicate a page can be scrolled to the right as well as the left. The method can proceed from step 230 to step 235.

Further, the method can proceed from step 225 directly to step 235 when the page is not scrollable horizontally. In step 235, an event indicating that a scrolling event has occurred can be detected. If no such event has occurred, the GUI screen can remain unchanged and further scrolling events can be awaited (a looping of step 235 can occur). If the page is scrolled, however, the method can proceed to step 210, were the page can be re-rendered and a new determination can be made as to whether the newly rendered page is scrollable.

If in step 210, a page is not scrollable, the method can proceed to step 240. In step 240, the GUI can be checked to see if a flyover is presently visible. If so, the method can proceed to step 245 where the flyover can be removed. If no flyovers are visible in step 240, the method can proceed from step 240 directly to step 250. In step 250, a new page can be retrieved resulting in the method restarting, by looping to step 205. If no new page is to be retrieved, the method can instead end.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method for indicating that a content page is scrollable comprising the steps of:
displaying a content page within a display area;
determining that at least a portion of the displayed content page is scrollable; and
responsive to said determination, displaying a flyover to indicate that said content page is scrollable.

2. The method of claim 1, wherein said determining step further comprises the step of:
determining that said displayed content page is scrollable vertically, wherein said flyover includes a vertical flyover.

3. The method of claim 1, wherein said determining step further comprises the step of:
determining that said displayed content page is scrollable horizontally, wherein said flyover includes a horizontal flyover.

4. The method of claim 1, further comprising the step of:
scrolling said displayed content page in at least one scrollable direction, wherein a position of said flyover remains fixed during said scrolling step.

5. The method of claim 1, further comprising the steps of:
detecting a flyover-close event; and
responsive to said flyover-close event, closing at least one flyover.

6. The method of claim 5, said detecting step further comprising the step of:
determining an occurrence of a scroll event, wherein said scroll event triggers said flyover-close event.

7. The method of claim 5, said detecting step further comprising the step of:
determining that said content page has been scrolled so that an end point of the content page has been displayed, wherein said display of content triggers said flyover-close event.

8. The method of claim 1, further comprising the steps of:
providing a configuration editor for altering at least one of a positioning, appearance, and behavior of said flyover.

9. The method of claim 1, further comprising the steps of:
implementing said flyover on an operating system level as a generic graphical user interface object.

10. A system for indicating that a content page is scrollable comprising the steps of:
a flyover graphical user interface item configured to indicate that a content page is scrollable, wherein said flyover is a generic software object implemented at an operating system level;
means for displaying a content page within a display area;
means for determining that at least a portion of the displayed content page is scrollable; and
means for displaying said flyover responsive to said determination.

11. The system of claim 10, wherein said flyover is implemented within an operating system specifically designed for a mobile computing device, wherein said mobile computing device comprises at least one of a personal data assistant and a cellular telephone.

12. A machine-readable storage having stored thereon, a computer program having a plurality of code sections, said code sections executable by a machine for causing the machine to perform the steps of:
displaying a content page within a display area;
determining that at least a portion of the displayed content page is scrollable; and
responsive to said determination, displaying a flyover to indicate that said content page is scrollable.

13. The machine-readable storage of claim 12, wherein said determining step further comprises the step of:
determining that said displayed content page is scrollable vertically, wherein said flyover includes a vertical flyover.

14. The machine-readable storage of claim 12, wherein said determining step further comprises the step of:
determining that said displayed content page is scrollable horizontally, wherein said flyover includes a horizontal flyover.

15. The machine-readable storage of claim 12, further comprising the step of:
scrolling said displayed content page in at least one scrollable direction, wherein said position of said flyover remains fixed during said scrolling step.

16. The machine-readable storage of claim 12, further comprising the steps of:
detecting a flyover-close event; and
responsive to said flyover-close event, closing at least one flyover.

17. The machine-readable storage of claim 16, said detecting step further comprising the step of:
determining an occurrence of a scroll event, wherein said scroll event triggers said flyover-close event.

18. The machine-readable storage of claim 16, said detecting step further comprising the step of:
determining that said content page has been scrolled so that an end point of the content page has been displayed, wherein said display of content triggers said flyover-close event.

19. The machine-readable storage of claim 12, further comprising the steps of:
providing a configuration editor for altering at least one of a positioning, appearance, and behavior of said flyover.

20. The machine-readable storage of claim 12, further comprising the steps of:
implementing said flyover on an operating system level as a generic graphical user interface object.
